(19) United States
(12) Patent Application Publication
(10) Pub. No.: US 2024/0373112 A1
(43) Pub. Date: Nov. 7, 2024

(54) VISUAL INSPECTION DEVICE

(71) Applicant: MILWAUKEE ELECTRIC TOOL CORPORATION, Brookfield, WI (US)

(72) Inventors: Christopher J. Turner, Lannon, WI (US); Francisco J. Hernandez, Brookfield, WI (US)

(21) Appl. No.: 18/652,099

(22) Filed: May 1, 2024

Related U.S. Application Data
(60) Provisional application No. 63/463,198, filed on May 1, 2023.

(51) Int. Cl. H04N 23/50; G01J 5/00; G01J 5/08; H04N 7/18

(52) U.S. Cl. CPC H04N 23/555; G01J 5/0859; H04N 7/181; G01J 2005/0077

(57) ABSTRACT

A system comprises a cable including an image capture device positioned at a distal end of the cable, the image capture device configured to output digital data. The system includes a digital to analog circuit at the distal end of the cable and in communication with the image capture device, the digital to analog circuit is configured to convert digital data into analog data. The system includes an analog to digital circuit at the proximal end of the cable and in communication with the digital to analog circuit, the analog to digital circuit is configured to convert analog data to received digital data. The system also includes a monitoring device including a display and a connector. The connector is configured to electrically, mechanically, and detachably interface with the proximal end of the cable, and the monitoring device is configured to display images captured by the image capture device.

### CROSS-REFERENCE TO RELATED APPLICATIONS

This application claims priority to U.S. Provisional Patent Application No. 63/463,198 filed on May 1, 2023, the entire contents of which are incorporated herein by reference.

### FIELD

The present invention relates to inspection devices for inspecting sewers, drains, pipes, or other conduits.

### SUMMARY

A pipeline inspection system is a type of technology that is used to inspect and monitor pipelines for defects, damages, and other issues that could potentially lead to leaks or other undesired pipe conditions. The pipeline inspection system typically consists of several key components, including sensors, cameras, and other measurement devices that are mounted onto a device that can travel through the pipeline. The sensors and cameras in the system gather data about the pipeline as the inspection tool moves through it. This data is then transmitted to a control system for analysis. The control system may use specialized software to interpret the data and identify potential issues, such as corrosion, cracks, or other forms of damage. It is therefore advantageous to include more sophisticated sensors and cameras to improve the inspection of the pipeline.

In one embodiment, an inspection system includes a cable including an image capture device positioned at a distal end of the cable, where the image capture device is configured to output digital data. The system includes a digital to analog circuit at the distal end of the cable and in electronic communication with the image capture device, where the digital to analog circuit is configured to convert digital data from the image capture device into analog data. The system includes an analog to digital circuit at the proximal end of the cable and in communication with the digital to analog circuit, where the analog to digital circuit is configured to convert analog data received from the digital to analog circuit to received digital data. The system also includes a monitoring device, the monitoring device including a display and a connector. The connector is configured to electrically, mechanically, and detachably interface with the proximal end of the cable, and the monitoring device is configured to display images captured by the image capture device in response to receiving the received digital data.

Another embodiment includes an inspection device that includes a housing, the housing including a receptacle configured to receive a removable, rechargeable battery pack. The device includes a connection port, the connection port configured to detachably coupled with one of a first camera and an inspection cable having a second camera coupled to a distal end, wherein a proximal end of the inspection cable includes a connector for detachably coupling with the connection port. The device includes a display configured to display images captured by the first camera and the second camera, wherein in response to the first camera being interfaced with the connection port, the display displays images captured by the first camera, and wherein in response to the connector of the cable being interfaced with the connection port, the display displays images captured by the second camera.

Another embodiment describes an inspection cable that includes an image capture device positioned at a distal end of the cable, wherein the image capture device is configured to output digital data. The inspection cable further includes a digital to analog circuit at the distal end of the cable and in electronic communication with the image capture device, wherein the digital to analog circuit is configured to convert digital data from the image capture device into analog data. The inspection cable also includes an analog to digital circuit at the proximal end of the cable and in communication with the digital to analog circuit, wherein the analog to digital circuit is configured to convert analog data received from the digital to analog circuit to received digital data.

Before any embodiments are explained in detail, it is to be understood that the embodiments are not limited in application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”).

As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors.

Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 is an illustration of a pipeline inspection device, according to some aspects and examples.

FIG. 2 is a detailed illustration of a display device for use with the pipeline inspection device of FIG. 1, according to some aspects and examples.

FIG. 3 is an illustration of an alternative perspective view of the display device of FIG. 2, according to some aspects and examples.

FIG. 4 is an illustration of an alternative perspective view of the display device of FIG. 2, according to some aspects and examples.

FIG. 5 is an alternative illustration of display device of FIG. 1, according to some aspects and examples.

FIG. 6 is an illustration of a use of the display device of FIG. 1, according to some aspects and examples.

FIG. 7 is an illustration of an enhanced inspection cable, according to some aspects and examples.

### DETAILED DESCRIPTION

A pipeline inspection device is an apparatus that inspects the interior of pipelines to identify any damages or defects. The device may include image capture devices, cameras, sensors, navigation systems, data storage, and communication systems. The image capture device may capture images of the inside of the pipe, while sensors collect data about the conditions within. Navigation systems help the device operator track the device's location, and data storage allows the operator to review and analyze the data. Communication systems enable the device to transmit data to a control center or remote operator. Examples and embodiments described herein relate to display devices for use with a pipeline inspection device. In some examples, the display device may be useable with a borescope to allow for captured images to be displayed thereon. Additionally or alternatively, the display device may directly attach to a borescope camera. In some instances, the display device is directly coupled to an image capture device, allowing an operator to use the display device to examine an area.

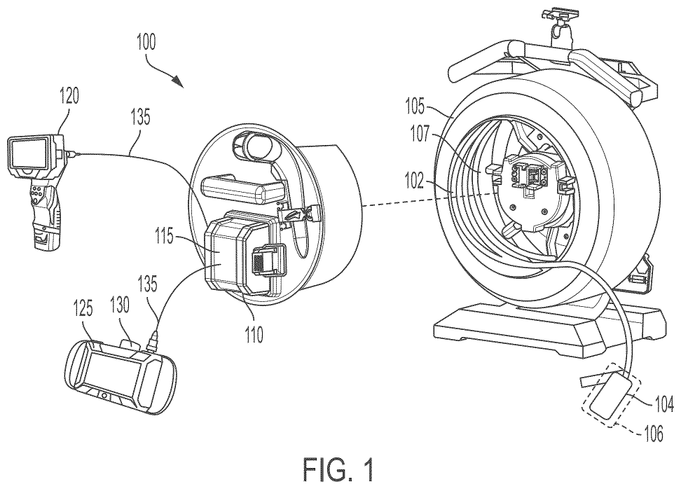

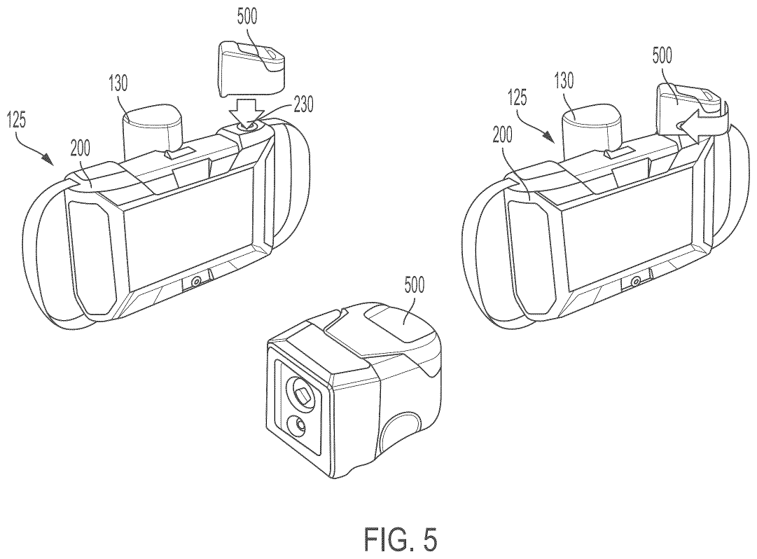

FIG. 1 illustrates a pipeline inspection device 100 including a reel housing 105 and a push cable 102 with an image capture device 104, also referred to as a camera, connected to the push cable 102. In some examples, the push cable 102 may be referred to as an inspection cable. The push cable 102 is stored on a reel 107 within the reel housing 105 such that that the push cable 102 may be wound and unwound (i.e., spooled and unspooled) as needed by an operator of the pipeline inspection device 100. In some instances, the image capture device 104 is detachably connected to the push cable 102, such that multiple image capture devices may be interchangeably connected and disconnected from the push cable 102. The image capture device 104 is illustrated in FIGS. 5-7 and described in greater detail below.

The pipeline inspection device 100 also includes a hub 110. The hub 110 includes a battery receptacle that selectively receives a battery pack (e.g., a power tool battery pack) to power the pipeline inspection device 100. The hub 110 also includes electronics, such as an image processor and/or a wireless transceiver, to control operation of the pipeline inspection device 100. The hub 110 is configured to connect to a display, such as a tablet, smartphone, laptop, or similar device configured to display images captured by the image capture device 104. The pipeline inspection device 100 also includes an input/output interface 115 configured to electrically communicate with handheld devices, such as image capture device 104, a handheld controller 120, and a monitor, also referred to as display device 125. However, in other examples, the handheld controller 120 may be coupled directly to the image capture device 104 via the push cable 102. In some instances, the handheld devices are battery powered. For example, handheld controller 120 and/or the display device 125 may be powered by a detachable, rechargeable battery pack 130. In other instances, display device 125 connects to the input/output interface 115 by way of a cable 135, where the cable is configured to provide power and enable communication between the display device 125 and the pipeline inspection device 100. For example, the cable 135 may include a USB-C connector enable electrical communication between the connected devices. In other instances, display device 125 connects to the pipeline inspection device 100 wirelessly via a near field communication (NFC) connection, a short-range wireless connection (for example, a Bluetooth® connection), an IEEE 802.11 protocol connection (for example, Wi-Fi), or the like.

In some instances, the image capture device 104 includes a removable and disposable cover 106 (referred to as cover 106) configured to protect the image capture device 104. The cover 106 is configured to protect the image capture device 104 as it passes through a pipe. For example, old pipes often require a relining procedure that includes releasing a resin within the pipe and solidifying the resin with a UV light. During this process, the resin may coat the lens of an uncovered image capture device, thereby damaging or destroying the image capture device. However, by including a removable and disposable cover 106, the image capture device 104 may be protected from damage during use. In one embodiment, the cover 106 may be optically transparent to allow for the image capture device 104 to capture images even when enclosed within the cover 106.

In some examples, the cover 106 is molded out of polycarbonate and may include two pieces joined together to enclose and cover the image capture device 104. In other examples, a silicone tube or sleeve is provided together or as separate piece from the cover 106, where the silicone tube additionally covers a portion of the cable used for relining pipes. In some examples, the cover 106 may be configured to be disposable. However, in other examples, the cover may be configured to be reusable.

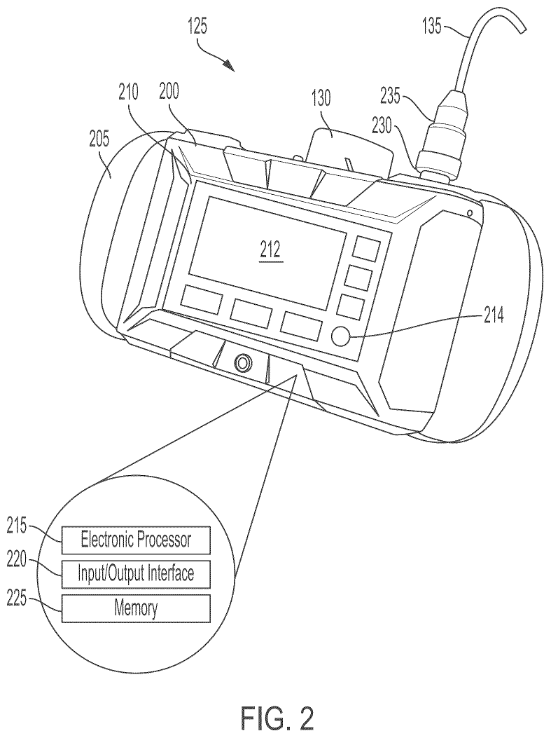

FIG. 2 is an illustration of the display device 125 described above, according to some aspects and examples. The display device 125 may also be called a borescope or part of a borescope. The display device 125 includes a housing 200. The housing 200 includes handles 205 such that the operator of the display device 125 may securely hold the display device 125. The display device 125 also includes a display 210 for viewing an image or video captured by the image capture device 104.

In some instances, the display 210 also includes a user interface 212 for controlling an image capture device, such as image capture device 104, configuring a setting of the image capture device or of the display 210, configuring a wirelessly connected device, or setting other features of the display device 125 and/or devices coupled to the display device. The user interface 212 may include a number of inputs 214 (e.g., push buttons, soft keys, touch screen icons, etc.) configured to allow the operator to control one or more aspects of the display device 125 and/or a connected device, such as controlling the settings of the display 210, the image capture device 104, or features of other connected devices, such as the pipeline inspection device 100, a connected imaging device (see below), or other component as required for a given application. In some instances, the display 210 includes a resolution of 120×90 pixels. However, in display resolutions of more than 120×90 pixels or less than 120×90 pixels are also contemplated as required for a given application.

In some instances, the display device 125 also includes an electronic processor 215, an input/output interface 220, and a memory storage 225. In some examples, the electronic processor 215 is implemented as a microprocessor with separate memory, for example the memory storage 225. In other examples, the electronic processor 215 may be implemented as a microcontroller (with memory storage 225 on the same package). In other examples, the electronic processor 215 may be implemented using multiple processors. In addition, the electronic processor 215 may be implemented partially or entirely as, for example, a field-programmable gate array (FPGA), an applications specific integrated circuit (ASIC), and the like and the memory storage 225 may not be needed or be modified accordingly. In some examples, the memory storage 225 includes non-transitory, computer-readable memory that stores instructions that are received and executed by the electronic processor 215 to carry out methods described herein.

The memory storage 225 may include, for example, a program storage area and a data storage area. For instance, programs for processing images captured by the image capture device 104 of the pipeline inspection device 100 may be stored in the memory storage 225. The memory storage 225 may include embedded multimedia card (eMMc) memory for storing associated programs/firmware, etc. However, other memory types are also contemplated as required for a given application. In some instances, the captured and processed images may be saved to another location or device, such as on a Micro SD card or other memory storage devices required for a given application. The program storage area and the data storage area may include combinations of different types of memory, for example read-only memory and random-access memory. The input/output interface 220 may include one or more input mechanisms and one or more output mechanisms (for example, general-purpose input/outputs (GPIOs), a network bus interface, analog inputs, digital inputs, Universal Serial Bus (“USB”) and others as required for a given application). The display device 125 includes a connection port 230 for electrically and mechanically interfacing with a connector 235 of the cable 135 to the display device 125. The connection port 230 may be, for example, a 6-pin keyed round connector. The connector 235 may be an associated 6-pin keyed round connector configured to interface with the connection port 230. However, other connection port and associated connector types are contemplated as required for a given application. The display device 125 also includes rechargeable battery pack 130 as previously described.

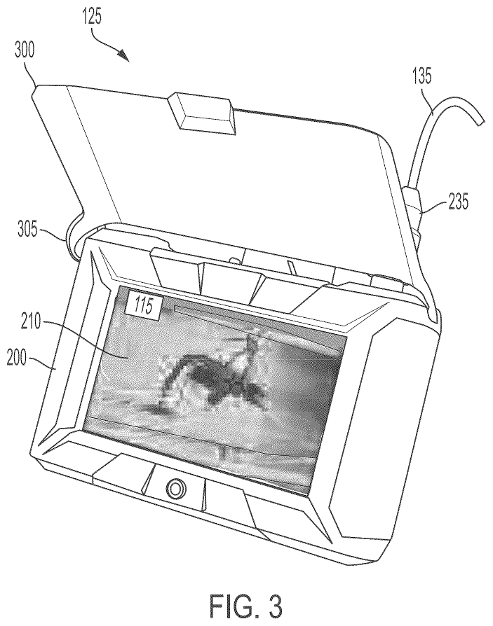

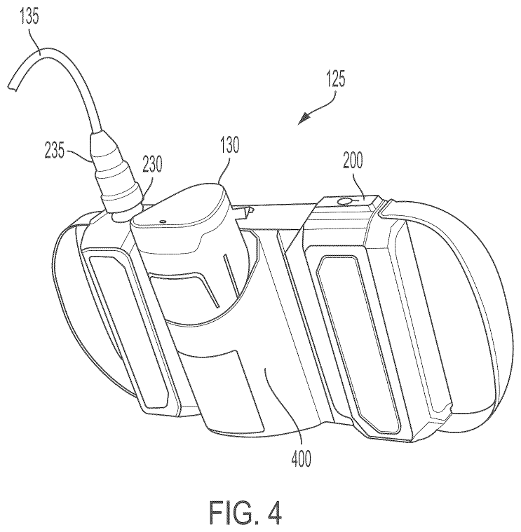

FIG. 3 and FIG. 4 are alternative perspectives of the display device 125, according to some aspects and examples. In some examples, the display device 125 includes a movable cover 300 for the display 210 attached to the housing 200 by a hinge portion 305. The movable cover 300 provides additional protection for the display 210 when the movable cover 300 is closed and allows the operator of the display device 125 to shade the display 210 from undesired illumination when the movable cover 300 is open. In the illustration of FIG. 3, the display 210 is shown displaying an image captured by the image capture device 104. FIG. 4 illustrates another view of the display device 125. From this perspective, the rechargeable battery pack 130 is illustrated electrically coupled with a battery charger receptacle 400 attached to the housing 200 of the display device 125.

FIG. 5 is an illustration of the display device 125 including a direct connection (i.e., no intervening cables or other coupling devices) between an image capture device 104 and the display device 125, according to some aspects and examples. In this instance, a thermal image capture device 500 (or thermal imaging camera) is configured to detachably connect (mechanically and electrically) to the connection port 230 of the display device 125 and be used to view an area. Instead of attaching the display device 125 to the pipeline inspection device 100 via the cable 135, an operator may attach the thermal image capture device 500. The thermal image capture device 500 is configured to detect the thermal radiation emitted by objects in its field of view. For instance, in some examples, the thermal image capture device 500 has a lens that focuses infrared radiation onto an array of sensors, which then convert the radiation into an electrical signal. The electrical signal is then processed by the display device 125 and displayed as an image on the display 210. In some examples, the electrical signal may be an encoded (or decoded) video signal for display by the display 210.

For example, a user of the display device 125 may wish to observe a large area of pipes to determine temperature anomalies (e.g., cold spots, hot spots, etc.). In another example, a user of the display device 125 may wish to observe various thermal levels of an automotive motor in order to specifically target maintenance operations. In yet another example, a user of the display device 125 may wish to determine where heat is escaping from an area, such as an enclosed insulated space like the room of a house. The attachment of the thermal image capture device 500 directly to the display device 125 allows for a wide range of applications to be thermally analyzed. For example, operator may choose to use the thermal image capture device 500 attached to the display device 125 to analyze multiple pipes before selecting a particular pipe with which to use the push cable 102 and image capture device 104. In this way the operator advantageously saves time and equipment costs by adapting the display device 125 to each task.

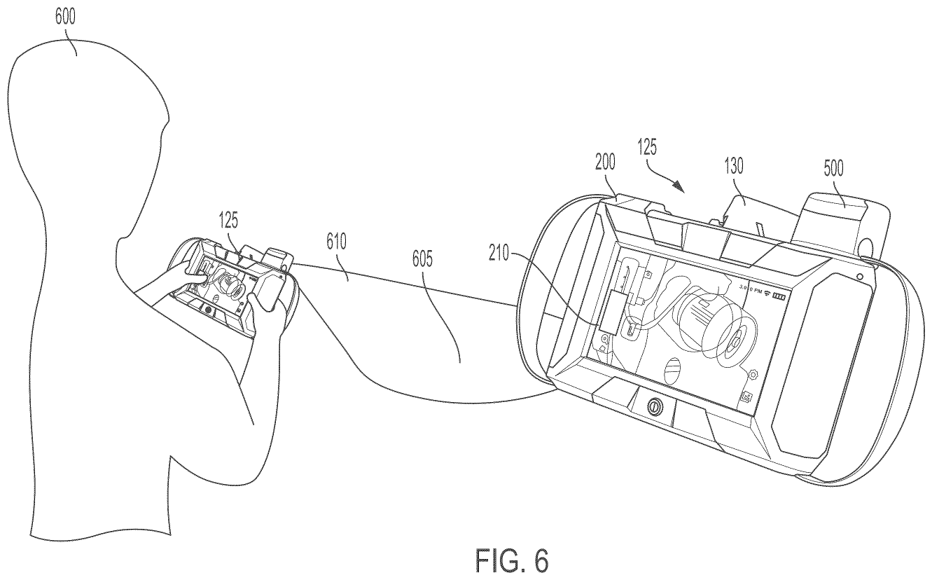

FIG. 6 is an illustration of the display device 125 and a thermal image capture device 500 in use by an operator, according to some aspects and examples. Operator 600 is illustrated holding the housing 200 of the display device 125 and pointing the thermal image capture device 500, also referred to as a camera, towards a surface 605. Additionally illustrated is the thermal image capture device 500 field of view 610. The field of view 610 may range up to and including 15 feet or approximately 4.5 meters. The operation of the display device 125 and thermal image capture device 500 by the operator 600 functions as previously described, and the field of view 610 may include objects of interest to the operator 600.

In addition to the thermal image capture device 500, an operator may choose to attach other image capture devices to the display device 125 via the connection port 230. For example, the operator may choose to attach a standard image capture device (e.g., camera), an image capture device with a flash, an image capture device with a low-light lens, an image capture device with active infrared, or the like. By allowing the display device 125 to interchangeably accept detachable image capture devices, the display device 125 advantageously allows the operator to select a desired image capture device for their task. In some examples, the thermal image capture device 500 and/or other image capturing devices may be connected to the display device via a connector. The connector may be a standard connector, such as USB-A, USB-C, Firewire, Lightning, or may be proprietary connector for use with the display device 125 and associated components.

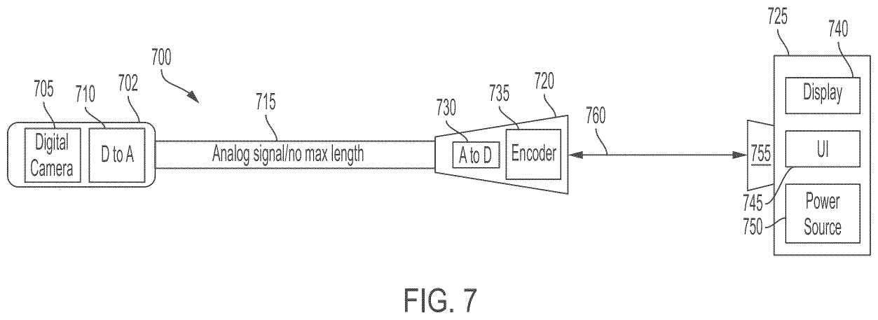

FIG. 7 is an illustration of an inspection cable 700, according to some aspects and examples. The inspection cable includes a distal end 702 connected to a digital image capture device 705, similar to image capture device 104. The distal end 702 of the inspection cable 700 also includes a digital-to-analog circuit 710, also referred to as a D/A converter or a DAC, for converting the digital image captured by the digital image capture device 705 into an analog signal 715 to be transmitted through the push cable 102. The analog signal 715 is a continuous wave that represents a continuous range of values, and advantageously may travel down inspection cable 700 with minimal deterioration or signal loss when compared to a digital signal. This allows the inspection cable to have lengths of up to 75 feet, or approximately 23 meters. However, in some implementations, cable lengths of more than 75 feet are contemplated. For instance, in some instances, a cable may range between 50 feet to 300 feet. Digital signals may be limited to distances of less than 50 feet.

The inspection cable 700 interfaces with a device 725 at a proximal end opposite the distal end. The proximal end 720 of the inspection cable 700 includes an analog to digital circuit 730, also referred to as a A/D converter or ADC, and an encoder 735. The encoder may be a MJPEG encoder, also referred to as a Motion JPEG encoder. The analog to digital circuit 730 converts the analog signal 715 that is transmitted along the length of the inspection cable 700 into a digital signal that includes a collection of images captured by the digital image capture device 705. The digital signal is then transmitted to the encoder 735. Once the digital signal is received by the encoder 735, the encoder 735 processes the digital signal into images for display on a display of the device 725. Other metadata may also be encoded within the digital signal, such as camera settings (frames per second, ISO values, aperture values, shutter speed, lighting levels, etc.), environmental data (temperature, humidity, etc.) and/or other data as required for a given application.

As previously described, the proximal end 720 is configured to connect to a device 725. In some instances, the device 725 is the pipeline inspection device 100 of FIG. 1. In other instances, the device 725 may be a handheld controller, such as handheld controller 120, or a display device, such as display device 125, a personal computer, a smartphone, a tablet, or any other device configured to interface with the push cable 102. The device 725 may include a display 740, a user interface 745, and a power source 750. The device 725 also includes a connector 755 to facilitate the connection between the push cable 102 and the device 725. Once the connector 755 is connected to the device 725, the encoder 735 transmits the sequence of images, or signal 760, to the device 725 for presentation on the display 740. By locating the analog to digital circuit 730 and encoder 735 within the cable 135, the device 725 is not required to be a special purpose device configured to convert analog signals transmitted by the digital-to-analog circuit 710, and/or encode received data to allow for display of the received data. This advantageously allows for general purpose devices, such as those described above, to be used with the inspection cable 700.

In some examples, the proximal end of the inspection cable 700 may terminate in a connector, to allow for the cable to be directly coupled to a device, such as device 725, as those described above. The connector may be a USB connector, a USB-C connector, a thunderbolt connector, a 6-pin keyed round connector, or any other applicable connector type that facilitates connection between the push cable 102 (and therefore the digital image capture device 705) and the display device.

In some instances, the inspection cable 700 may be a cable typically used with a borescope. Thus, the inspection cable 700 can allow the device 725 to function as a borescope.

Accordingly, various implementations of the systems and methods described herein provide, among other things, a system of pipeline inspection. Other features and advantages of the invention are set forth in the following claims.

In the foregoing specification, specific examples have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus.

An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting example the term is defined to be within 10%, in another example within 5%, in another example within 1% and in another example within 0.5%. The term “coupled” as used herein is defined as connected, although not necessarily directly and not necessarily mechanically. A device or structure that is “configured” in a certain way is configured in at least that way but may also be configured in ways that are not listed.

What is claimed is:

1. An inspection system, the system comprising:
a cable including:
an image capture device positioned at a distal end of the cable, wherein the image capture device is configured to output digital data;
a digital to analog circuit at the distal end of the cable and in electronic communication with the image capture device, wherein the digital to analog circuit is configured to convert digital data from the image capture device into analog data;
an analog to digital circuit at a proximal end of the cable and in communication with the digital to analog circuit, wherein the analog to digital circuit is configured to convert analog data received from the digital to analog circuit to received digital data; and
a monitoring device, the monitoring device including a display and a connector, the connector configured to electrically, mechanically, and detachably interface with the proximal end of the cable;
wherein the monitoring device is configured to display images captured by the image capture device in response to receiving the received digital data.

2. The system of claim 1, wherein the cable further includes an encoder configured to encode the received digital data.

3. The system of claim 1, wherein the cable measures at least 75 feet from the proximal end to the distal end.

4. The system of claim 1, wherein the system further includes a cover for the image capture device, the cover detachably connected to the image capture device.

5. The system of claim 4, wherein the cover includes a first portion and a second portion, the first portion and the second portion configured to mechanically couple to each other and the image capture device.

6. The system of claim 5, wherein the cover is constructed out of polycarbonate.

7. The system of claim 5, wherein the cover includes a silicone tube for covering the image capture device and the distal end of the cable.

8. An inspection device, the inspection device comprising:
a housing, the housing including a receptacle configured to receive a removable, rechargeable battery pack;
a connection port, the connection port configured to detachably coupled with one of a first camera and an inspection cable having a second camera coupled to a distal end; wherein a proximal end of the inspection cable includes a connector for detachably coupling with the connection port;
a display configured to display images captured by the first camera and the second camera;
wherein in response to the first camera being interfaced with the connection port, the display displays images captured by the first camera; and
wherein in response to the connector of the cable being interfaced with the connection port, the display displays images captured by the second camera.

9. The inspection device of claim 8, wherein the first camera is a thermal imaging camera.

10. The inspection device of claim 8, wherein the second camera is a digital camera.

11. The inspection device of claim 8, wherein the second camera includes a cover, the cover detachably connected to the second camera.

12. The inspection device of claim 11, wherein the cover includes a first portion and a second portion, the first portion and the second portion configured to mechanically couple to each other and the second camera.

13. The inspection device of claim 11, wherein the cover is constructed out of polycarbonate.

14. The inspection device of claim 11, wherein the cover includes a silicone tube for covering the second camera and the distal end of the cable.

15. The inspection device of claim 8, wherein the inspection cable includes an analog-to-digital converter and an image encoder configured to encode data received from the second camera into image data able to be displayed by the display.

16. The inspection device of claim 15, wherein the analog-to-digital converter and the image encoder are positioned at a proximal end of the inspection cable.

17. The inspection device of claim 15, wherein the image encoder is an MJPEG encoder.

18. An inspection cable, comprising:
an image capture device positioned at a distal end of the cable, wherein the image capture device is configured to output digital data;
a digital to analog circuit at the distal end of the cable and in electronic communication with the image capture device, wherein the digital to analog circuit is configured to convert digital data from the image capture device into analog data; and
an analog to digital circuit at a proximal end of the cable and in communication with the digital to analog circuit, wherein the analog to digital circuit is configured to convert analog data received from the digital to analog circuit to received digital data.

19. The inspection cable of claim 18, wherein the cable further includes an encoder configured to encode the received digital data.

20. The inspection cable of claim 18, wherein the cable measures at least 50 feet from the proximal end to the distal end.
